(19) United States
(12) Patent Application Publication
(10) Pub. No.: US 2016/0318295 A1
(43) Pub. Date: Nov. 3, 2016

(54) A DEVICE FOR TEARING OFF A POLARIZER AND METHOD THEREOF

(71) Applicant: SHENZHEN CHINA STAR OPTOELECTRONICS TECHNOLOGY CO., LTD., Shenzhen, Guangdong (CN)

(72) Inventor: Zhicheng Liu, Shenzhen, Guangdong (CN)

(21) Appl. No.: 14/647,106

(22) PCT Filed: Jan. 20, 2015
(86) PCT No.: PCT/CN2015/071074

§ 371 Date: May 25, 2015

(30) Foreign Application Priority Data
Jan. 21, 2014 (CN) 201410028513.3

(51) Int. Cl. B32B 43/00; G02F 1/1335; G02F 1/13

(52) U.S. Cl. CPC B32B 43/006; G02F 1/1309; G02F 1/133528

(57) ABSTRACT

The present invention discloses a device for tearing off a polarizer and a method for tearing off a polarizer. The device for tearing off a polarizer comprising a tearing platform, a clamping module and a liquid injecting module, wherein the tearing platform is used to fix a glass panel, the clamping module is used to clamp the tearing corner of the polarizer which is adhered to the glass panel and has an adhesion defect, the liquid injecting module is used to spray a liquid onto the junction between the polarizer and the glass panel. According to an embodiment, the adhesive force between the polarizer and the glass panel can be reduced and the tearing efficiency can be improved.

### FIELD OF THE INVENTION

The present invention pertains to the technical field of TFT LCD (Thin-film-transistor liquid crystal display), and in particular relates to a device for tearing off a polarizer and a method for tearing off a polarizer.

### BACKGROUND OF THE INVENTION

When the polarizer adhered to the glass panel for LCD or flat panel TV has an adhesion defect, polarizer repair or polarizer peeling procedure will be performed. The polarizer with adhesion defect will be torn off. However, the size of the polarizer is large, and the adhesive force of the polarizer is large due to heating after adhesion, the removing of the polarizer become difficult. It is easy to cause a fracture of the polarizer and a damage of the glass panel.

### SUMMARY OF THE INVENTION

The present invention provides a device for tearing off a polarizer, which can reduce the adhesive force between the polarizer and the glass panel and improve the tearing efficiency.

The present invention is realized in such a way that: A device for tearing off a polarizer, the device for tearing off a polarizer comprising a tearing platform, a clamping module and a liquid injecting module, the tearing platform is used to fix a glass panel, the clamping module is used to clamp the tearing corner of the polarizer which is adhered to the glass panel and has an adhesion defect, the liquid injecting module is used to spray a liquid onto the junction between the polarizer and the glass panel.

Preferably, the liquid injecting module and the tearing platform move synchronously in horizontal direction.

Preferably, the liquid from the liquid injecting module is water.

Preferably, the device for tearing off a polarizer further comprises a maintaining module for keeping the tearing corner at a torn state.

Preferably, the maintaining module is an air knife.

According to another aspect of the present invention, a method for tearing off a polarizer is provided, the method for tearing off a polarizer comprising the following steps:

a fixing step for fixing a glass panel on a tearing platform;

a starting step for tearing off the tearing corner on a polarizer which is adhered to the glass panel and has an adhesion defect and clamping the tearing corner by a clamping module; and

a spraying step for spraying liquid onto the junction between the polarizer and the glass panel.

Preferably, in the spraying step, the liquid injecting module and the tearing platform move synchronously in horizontal direction.

Preferably, the liquid from the liquid injecting module is water.

Preferably, the method for tearing off a polarizer further comprises a maintaining step for keeping the tearing corner at a torn state by a maintaining module.

Preferably, the maintaining module is an air knife.

According to the present invention, the device for tearing off a polarizer comprises a tearing platform, a clamping module and a liquid injecting module, the liquid injecting module is used to spray a liquid onto the junction between the polarizer and the glass panel, the adhesive force between the polarizer and the glass panel can be reduced and the tearing efficiency can be improved.

For more clearly and easily understanding above content of the present invention, the following text will take a preferred embodiment of the present invention with reference to the accompanying drawings for detail description as follows.

### BRIEF DESCRIPTION OF THE DRAWINGS

The drawings described herein are for illustration purposes only and are not intended to limit the scope of the present disclosure in any way.

FIG. 1 is a schematic sectional view of a comparative device for tearing off a polarizer, which is used to be compared with the device for tearing off a polarizer according to an embodiment of the present invention;

FIG. 2 is a schematic sectional view of the device for tearing off a polarizer according to an embodiment of the present invention;

FIG. 3 is a schematic sectional view of the device for tearing off a polarizer according to another embodiment of the present invention;

FIG. 4 is a schematic flowchart showing the method for tearing off a polarizer according to an embodiment of the present invention; and

FIG. 5 is a schematic flowchart showing the starting step of the method for tearing off a polarizer according to another embodiment of the present invention.

### DETAILED DESCRIPTION OF THE PREFERRED EMBODIMENTS

The embodiments of the present invention will be described in detail with reference to the accompanying drawings.

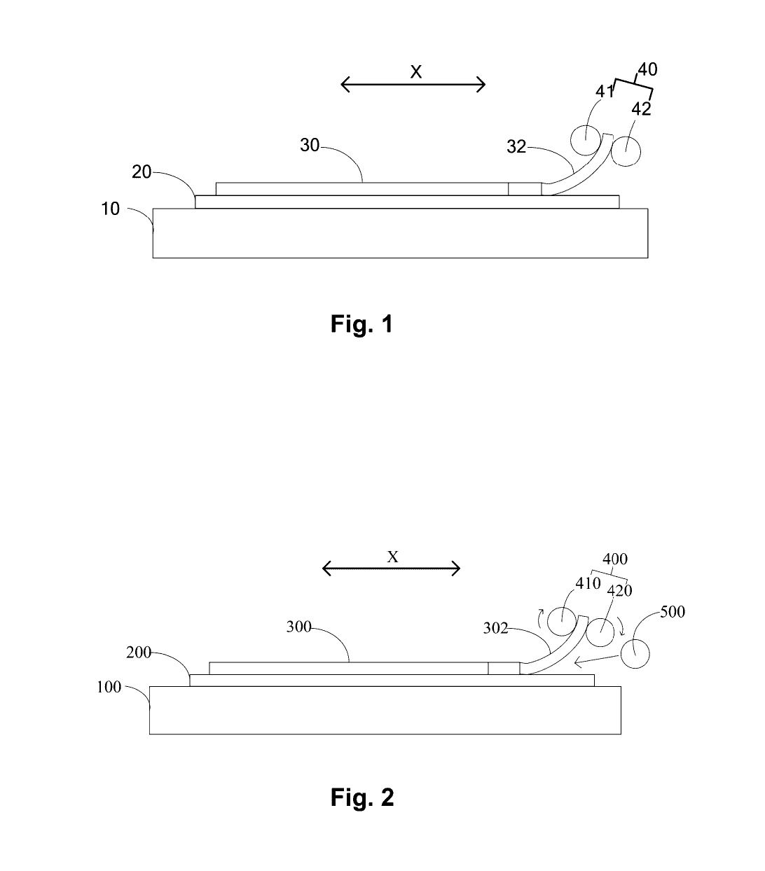

As shown in FIG. 1, a comparative device for tearing off a polarizer is can illustrated. This comparative device for tearing off a polarizer is used to be compared with the device for tearing off a polarizer according to an embodiment of the present invention, and it should not be considered as so called prior art. The comparative device for tearing off a polarizer comprises a tearing platform 10 and a clamping module 40. The tearing platform 10 is used to fix the glass panel 20. The clamping module 40 is used to clamp the tearing corner 32 of the polarizer 30 which is adhered to the glass panel 20 and has an adhesion defect. When it is necessary to tear off the polarizer 30 on the glass panel 20, firstly the glass panel 20 is fixed on the tearing platform 10. Then the glass panel 20 is driven to move towards the clamping module 40, so that the tearing corner 32 of the polarizer 30 is clamped by the clamping module 40. As shown in FIG. 1, the clamping module 40 comprises a front peeling roller 41 and a rear peeling roller 42. During the peeling procedure, the tearing corner 32 of the polarizer 30 is clamped between the front peeling roller 41 and the rear peeling roller 42. The clamping module 40 may comprise a claw for clamping the free end of the polarizer 30 additionally in other embodiments. When the tearing corner 32 of the polarizer 30 is clamped between the front peeling roller 41 and the rear peeling roller 42, the tearing platform 10 moves in the horizontal direction X. Since the tearing corner 32 of the polarizer 30 is clamped by the clamping module 40, and there is a relative movement between the tearing platform 10 and the clamping module 40, the polarizer 30 may be torn off.

When the tearing corner 32 of the polarizer 30 is clamped between the front peeling roller 41 and the rear peeling roller 42, the tearing platform 10 and/or the clamping module 40 moves in the horizontal direction X so as to form relative movement between the tearing platform 10 and the clamping module 40, the polarizer 30 may be torn off.

The peeling of the polarizer 30 or the repair of the polarizer 30 is carried out by external mechanical force. The polarizer 30 is adhered to the glass panel 20 by adhesive such as pressure sensitive adhesive. The adhesive force of the adhesive may change as time goes by and in subsequent process of LCD production. The strength of the polarizer 30 may be smaller than the adhesive force of the adhesive. In this case, the polarizer 30 may be fractured during tearing procedure. It will be troublesome when the polarizer 30 is fractured. Also, the glass panel 20 may be broken during tearing procedure.

As shown in FIG. 2, the device for tearing off a polarizer 300 of the present embodiment according to the present invention comprises a tearing platform 100, a clamping module 400 and a liquid injecting module 500. The tearing platform 100 is used to fix a glass panel 200. The clamping module 400 is used to clamp the tearing corner 302 of the polarizer 300 which is adhered to the glass panel 200 and has an adhesion defect. The liquid injecting module 500 is used to spray a liquid onto the junction between the polarizer 300 and the glass panel 200, such that the adhesive force of the adhesive is reduced dramatically. In the present embodiment, the adhesive is pressure sensitive adhesive.

In the device for tearing off a polarizer 300 of the present embodiment, the liquid injecting module 500 is provided. The liquid injecting module 500 is used to reduce the adhesive force of the adhesive. In a particular embodiment, the liquid injecting module 500 is a water injecting device. The liquid injecting module 500 injects water spray onto the junction between the polarizer 300 and the glass panel 200. When the adhesive contacts with the water, the adhesive force of the adhesive drops dramatically. The velocity of peeling will rise and the peeling efficiency will rise. Also the fracture of the polarizer and a damage of the glass panel can be avoided.

In some embodiment of the present invention, the liquid injecting module 500 and the tearing platform 100 move synchronously. In the embodiment illustrated in FIG. 2, the liquid injecting module 500 and the tearing platform 100 move synchronously in horizontal direction X. The clamping module 400 is static, and the tearing platform 100 moves. In the way, the polarizer 300 can be smoothly and quickly torn off from the glass panel 100.

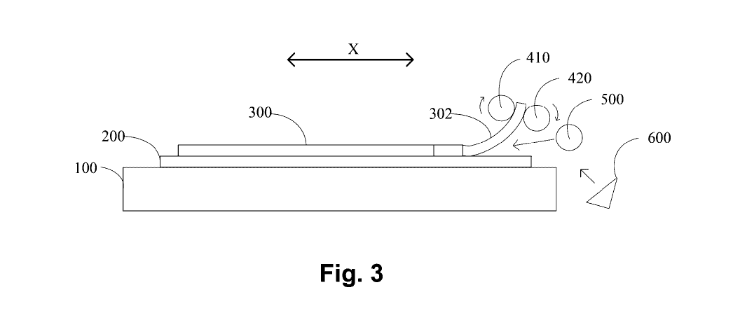

In the embodiment illustrated in FIG. 3, the device for tearing off a polarizer 300 further comprises a maintaining module 600 for keeping the tearing corner 302 at a torn state. In the present embodiment, the maintaining module 600 is an air knife.

The liquid injecting module 500 is a water injecting device. The hydraulic pressure and the quantity of the liquid injected by the liquid injecting module 500 can be adjusted as desired.

According to another aspect of the present invention, a method for tearing off a polarizer is provided. The method for tearing off a polarizer is carried out by means of the above-described device for tearing off a polarizer.

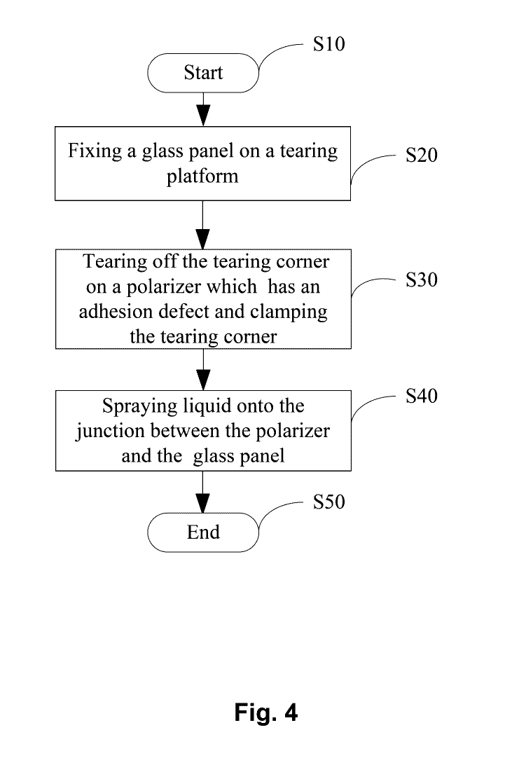

As shown in FIG. 4, the method for tearing off a polarizer comprises a start-up step S10, a fixing step S20, a starting step S30, a spraying step S40 and an ending step S50.

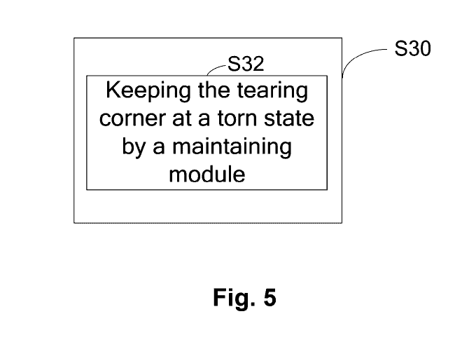

The fixing step S20 is used to fix the glass panel 200 on a tearing platform 100. The starting step S30 is used to tear off the tearing corner 302 on a polarizer 300 which is adhered to the glass panel 200 and has an adhesion defect and clamping the tearing corner 302 by a clamping module 400. The spraying step S40 is used to spray liquid onto the junction between the polarizer 300 and the glass panel 200, such that the adhesive force of the adhesive is reduced dramatically. In the spraying step S40, the liquid injecting module 500 and the tearing platform 100 move synchronously in horizontal direction. As shown in FIG. 5, the method for tearing off a polarizer 300 further comprises a maintaining step S32. The maintaining step S32 is used to keep the tearing corner 302 at a torn state by a maintaining module 600. The maintaining module 600 is an air knife. The maintaining module 600 applies air pressure onto the tearing corner 302.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A device for tearing off a polarizer, comprising a tearing platform, a clamping module and a liquid injecting module, wherein the tearing platform is used to fix a glass panel, the clamping module is used to clamp the tearing corner of the polarizer which is adhered to the glass panel and has an adhesion defect, the liquid injecting module is used to spray a liquid onto the junction between the polarizer and the glass panel.

2. The device for tearing off a polarizer of claim 1, wherein the liquid injecting module and the tearing platform move synchronously in horizontal direction.

3. The device for tearing off a polarizer of claim 1, wherein the liquid from the liquid injecting module is water.

4. The device for tearing off a polarizer of claim 1, wherein the device for tearing off a polarizer further comprises a maintaining module for keeping the tearing corner at a torn state.

5. The device for tearing off a polarizer of claim 1, wherein the maintaining module is an air knife.

6. A method for tearing off a polarizer, comprising the following steps:
a fixing step for fixing a glass panel on a tearing platform;
a starting step for tearing off the tearing corner on a polarizer which is adhered to the glass panel and has an adhesion defect and clamping the tearing corner by a clamping module; and
a spraying step for spraying liquid onto the junction between the polarizer and the glass panel.

7. The method for tearing off a polarizer of claim 6, wherein in the spraying step, the liquid injecting module and the tearing platform move synchronously in horizontal direction.

8. The method for tearing off a polarizer of claim 6, wherein the liquid from the liquid injecting module is water.

9. The method for tearing off a polarizer of claim 6, wherein the method for tearing off a polarizer further comprises a maintaining step for keeping the tearing corner at a torn state by a maintaining module.

10. The method for tearing off a polarizer of claim 9, wherein the maintaining module is an air knife.
